(19) United States
(12) Patent Application Publication
(10) Pub. No.: US 2009/0020922 A1
(43) Pub. Date: Jan. 22, 2009

(54) PRODUCTION METHOD OF POLYMER FILM AND PRODUCTION APPARATUS OF THE SAME

(75) Inventors: Akifumi Kato, Kanagawa (JP); Hidekazu Yamazaki, Kanagawa (JP)

Correspondence Address: YOUNG & THOMPSON, 209 Madison Street, Suite 500, ALEXANDRIA, VA, 22314, US

(73) Assignee: FUJIFILM CORPORATION, Tokyo (JP)

(21) Appl. No.: 12/281,455

(22) PCT Filed: Feb. 27, 2007
(86) PCT No.: PCT/JP2007/054142

§ 371 Date: Sep. 2, 2008

(30) Foreign Application Priority Data
Mar. 1, 2006 (JP) 2006-054511

(51) Int. Cl. B29B 13/08

(52) U.S. Cl. 264/484; 425/174.8 E

(57) ABSTRACT

A dope is cast onto a casting drum from a casting die while forming a casting bead. Oxygen concentration at the vicinity of the casting bead is set to 0 vol % or more and less than 10 vol %, and a static electricity applying electrode applies static electricity between the casting drum and the casting bead. An intervening film forming device supplies intervening film forming liquid onto the casting drum to form an intervening film. A compression chamber decompresses a downstream area from the casting bead. Thereby, it is possible to form the casting bead having a stable shape, and enhance the extent of adhesion between a casting film and the casting drum. Accordingly, it is possible to enhance the extent of adhesion between the casting drum and the casting bead, prevent occurrence phenomenon of air entrainment, and speed up a film forming speed, thus forming a polymer film.

### TECHNICAL FIELD

The present invention relates to a production method of a polymer film and a production apparatus of the same.

### BACKGROUND ART

A polymer film is easy to process and treat, and has advantages such as lightness and excellent transparency. Accordingly, the polymer film is used as an optical film for a liquid crystal display. As a production method of a polymer film, there is known a method in which a polymer is melted to form a film, and a method in which a solution containing a polymer dissolved in a solution (hereinafter referred to as a dope) is cast from a casting aperture of a casting die onto a support to form a casting film and then the casting film is peeled off to be dried. In the former method, since the temperature is increased to melt the polymer, the transparency of the film thus obtained tends to be lower than that obtained in the latter method. Accordingly, as a production method of an optical film, the latter method, that is, the solution casting method is preferable.

In the solution casting method, it is desired to speed up a film forming speed, and various investigations are made. However, when the film forming speed is made faster, a phenomenon of flow surge of a dope (casting bead) extending from the casting die to the support resulting in instability, and a phenomenon of air entrainment between the casting bead and the support are inclined to occur. Therefore, the casting film and the film formed after the above phenomenon may have poor planarity or defects. In view of the above, there has been proposed a method for enhancing the adhesion between the casting bead and the support to suppress vibration of the casting bead and phenomenon of air entrainment with use of static electricity application, a suction chamber, and an air knife (for example, see Japanese Patent Laid-Open Publication No. 2001-113544).

Recently, it is required that the film forming speed is further made faster in the solution casting method. Therefore, it is not sufficient to utilize static electricity application, the suction chamber, the air knife, and the like, since there occurs a phenomenon in which a portion extending from both side ends of the casting bead toward inside by 2 mm to 200 mm surges and has an unstable shape.

In view of the above, the object of the present invention is to provide a production method of a polymer film capable of preventing occurrence of phenomenon of air entrainment and stably casting a casting bead onto a support without vibrating the casting bead even when the film forming speed is made faster.

### DISCLOSURE OF INVENTION

According to the present invention, there is provided a production method of a polymer film including the steps of: casting a polymer solution containing a polymer and a solvent from a casting die onto a moving support to form a casting film; applying static electricity between the support and a casting bead extending from the casting die to the support at oxygen concentration set to 0 vol % or more and less than 10 vol %, an adhesion device increasing the extent of adhesion between the casting bead and the support; peeling off the casting film as a wet film from the support; and drying the wet film by a drier to form a polymer film.

It is preferable that the adhesion device includes at least one of a suction unit to decompress an upstream area from the casting bead in a running direction of the support, an air knife to flow air against the casting bead having reached the support, and a liquid layer forming unit to form a liquid layer between the support and the casting film by supplying a liquid thereto. Further, the liquid preferably contains the solvent.

According to the present invention, there is provided a production apparatus of a polymer film including: a casting film forming device for casting a polymer solution containing a polymer and a solvent from a casting die onto a moving support to form a casting film; a drying device for drying the casting film peeled from the support by a drier to form a polymer film; an oxygen concentration controlling unit for controlling oxygen concentration at the vicinity of a casting bead set to 0 vol % or more and less than 10 vol %, the casting bead extending from the casting die to the support; a static electricity application unit for applying static electricity between the casting bead and the support; and an adhesion device for increasing the extent of adhesion between the casting bead and the support. It is preferable that the adhesion device comprises at least one of a suction unit, an air knife, and a liquid layer forming unit.

According to the present invention, in an atmosphere satisfying a predetermined range of oxygen concentration, a dope is cast onto a support while applying static electricity thereto, and at least one suction device other than static electricity application is used. Therefore, in casting the dope, it is possible to enhance the extent of adhesion between the casting bead and the support while decreasing possibility of fire and explosion caused by the static electricity application. Further, even when speeding up the film forming speed, it is possible to form the casting bead having a stable shape without vibrating the casting bead while preventing occurrence of phenomenon of air entrainment. Accordingly, it becomes possible to produce a polymer film having excellent planarity even when the film forming speed is made faster.

### BRIEF DESCRIPTION OF DRAWINGS

FIG. 1 is a schematic diagram illustrating a film production apparatus according to an embodiment of the present invention;

FIG. 2 is a schematic diagram illustrating a casting die and its vicinity used in the embodiment;

FIG. 3 is a schematic diagram illustrating the casting die and its vicinity; and

FIG. 4 is a schematic diagram illustrating a dope production apparatus.

### BEST MODE FOR CARRYING OUT THE INVENTION

Embodiments of the present invention are described hereinbelow. The present invention, however, is not limited to the following embodiments.

Firstly, a film production apparatus of the present invention is described.

The film production apparatus 10 includes a casting chamber 12, a transfer section 13, a tenter device 14, a drying chamber 15, a cooling chamber 16, and a winding chamber 17.

The casting chamber 12 includes a feed block 20, a casting die 22, a casting drum 23 as a support, a cooling medium feeder 24, a peel roller 25, a condenser 26, a recovery device 27, a temperature regulator 28, and an oxygen meter 35. The casting die 22 is provided with a suction chamber 30. In the casting chamber 12, there is provided a liquid layer forming unit (hereinafter referred to as an intervening film forming device) 32 and a static electricity applying electrode 34.

An internal temperature of the casting chamber 12 is constantly maintained at a predetermined value by the temperature regulator 28. According to this embodiment, while forming a ribbon-shaped flow of dope (a casting bead), the dope is cast onto the casting drum 23 with its surface cooled from the casting die 22 to cool the dope, thus forming a casting film 40 in a gel-like state.

As described above, in order to cool a surface of the casting drum 23, in the casting drum 23, there is formed a channel of cooling medium fed from the cooling medium feeder 24, which is not shown in the drawing. The cooling medium with its temperature adjusted to a predetermined value is fed from the cooling medium feeder 24 into the channel to be circulated therein or pass therethrough, thus adjusting the temperature of the surface of the casting drum 23 at a predetermined value. Note that the surface temperature of the casting drum 23 is preferably in the range of −40° C. to 30° C. Thereby, the dope is efficiently cooled to form the casting film 40 in a gel-like state. The casting drum 23 is provided with a driver (not shown) and continuously rotates with its rotation frequency controlled by the driver.

The casting drum 23 is not especially limited as far as its surface temperature can be adjusted to a predetermined value. Accordingly, the width, the material, and the like of the casting drum 23 are not especially limited. However, it is preferable that the width of the casting drum 23 is approximately 1.1 to 2.0 times the casting width of the dope in order to obtain the casting film 40 having a desired width. As a material of the casting drum 23, it is preferable to use stainless in view of resistance to corrosion and the like. More preferably, SUS316 having sufficient resistance to corrosion and strength is used. Note that in order to form the casting film 40 having excellent planarity, it is preferable that the surface of the casting drum 23 is ground as many times as possible. The casting drum 23 includes a rotating drum having a peripheral surface onto which a dope is cast, and a running belt which is bridged between at least two backup rollers.

The casting film 40 is dried to have a self-supporting property. However, as the drying of the casting film 40 proceeds, the solvent in the casting film 40 is evaporated such that solvent vapor exists in the casting chamber 12. In view of the above, according to this embodiment, after the solvent vapor is condensed and liquidized by the condenser 26 to be recovered by the recovery device 27, the resultant is refined as a solvent for preparing the dope by a refining device (not shown). Thereby, it is possible to achieve reduction in cost of the material.

Next, the casting die 22 is explained. The casting die 22 is preferably a coat-hanger type die in order to maintain a width of the dope to be cast approximately constant. Although a width of the casting die 22 is not especially limited, it is preferable that the width of the casting die 22 is 1.1 to 2.0 times a width of a film 43 as a final product. Additionally, it is preferable that the surface of the casting die 22 is ground so as to have decreased unevenness. As a material of the casting die 22, precipitation hardened stainless steel is preferable in view of resistance to corrosion and the like. It is preferable that the material has resistance to corrosion such that pitting is not caused on a gas-liquid interface after being soaked in a mixed liquid of dichloromethane, methanol, and water for three months. Further, it is preferable that the resistance to corrosion is substantially equivalent to that of SUS316 subjected to a compulsory corrosion examination using an electrolyte aqueous solution. Note that a coefficient of thermal expansion thereof is preferably 2×10⁻⁵(° C.⁻¹) or less in order to suppress damage due to heat.

Moreover, it is preferable to make the casting die 22 by grinding a material after at least one month has passed since foundry. By virtue of this, the dope can smoothly and uniformly flow inside the casting die 22, thus making it possible to form the casting film 40 while preventing occurrence of streaks and the like. Slit clearance serving as a casting die of the dope is preferably adapted to be automatically adjusted within the range of 0.5 mm to 3.5 mm. With respect to a corner portion of a lip edge of the casting die 22, which contacts with liquid, a chamfered radius R thereof is preferably adapted to be 50 μm or less in the entire width. Shearing speed for the inside of the casting die 22 is preferably adjusted in the range of 1 to 5000 (1/second).

Further, the casting die 22 is preferably provided with a temperature controller (not shown) in order to maintain the temperature inside the casting die 22 at a predetermined level. The temperature controller makes the temperature of the dope to be approximately constant in a predetermined range.

Furthermore, it is preferable that thickness adjusting bolts (heat bolts) are disposed in a width direction of the casting die 22 at predetermined intervals and the casting die 22 is provided with an automatic thickness adjusting mechanism utilizing the heat bolts. It is preferable to control the heat bolts by a preset program so as to form a film while adjusting a liquid amount sent by a pump (not shown) used in feeding the dope to the casting die 22. In this case, a thickness gauge (such as an infrared thickness gauge) may be disposed inside the film production apparatus 10 to perform feedback control along an adjustment program on the basis of a profile of the thickness gauge. Note that it is preferable to regulate a thickness difference between any two points which are located within an area excepting an edge portion of the film to be 1 μm or less, and to regulate the difference between the maximum thickness and the minimum thickness to be 3 μm in the width direction of the film. Further, the thickness accuracy is preferably regulated to be plus or minus 1.5 μm or less.

Preferably, a hardened film is formed on the lip edge of the casting die 22 for the purpose of improving resistance to wear and the like. A method for forming the hardened film is not especially limited, however there are ceramic coating, hard chrome-plating, nitriding treatment, and the like, for example. When the ceramic is utilized as the hardened film, it is preferable that the ceramic can be ground, has low porosity, and is excellent in strength and resistance to corrosion, while having excellent adhesion to the casting die 22 and poor adhesion to the dope to be cast. Concretely, there are tungsten carbide (WC), Al₂O₃, TiN, Cr₂O₃, and the like. Among those, WC is especially preferable. It is possible to perform WC coating by a thermal spraying method.

It is preferable that a solvent supplying device (not shown) is attached to an end portion of the slit in order to supply the solvent for solubilizing the dope to be cast (such as a mixed solvent of 86.5 parts by mass of dichloromethane, 13 parts by mass of methanol, and 0.5 parts by mass of n-butanol) to the gas-liquid interface between the both side ends of the casting bead and ambient air and between the slit and the ambient air. Thereby, it is possible to prevent the dope, which flows into the end portion of the silt of the casting die 22, from being partially dried and solidified. The supply amount of the solvent for solubilization is not especially limited. However, it is preferable to supply the solvent for solubilization to each end portion of the silt at a rate of 0.1 mL/min to 1.0 mL/min. Owing to this, it is possible to prevent foreign substances from being mixed with the casting film 40. Note that, in supplying the solvent for solubilization, it is preferable to use the pump having a pulsation rate of 5% or less.

The transfer section 13 includes a plurality of rollers and a drying device 44. The casting film 40 is peeled from the casting drum 23 to obtain a wet film 41. In the transfer section 13, dry air adjusted to a predetermined temperature is blown against the wet film 41 from the drying device 44 while the wet film 41 is transported by the support of each of the rollers. Accordingly, the drying of the wet film 41 proceeds.

The tenter device 14 located in the downstream from the transfer section 13 preliminarily includes a heater (not shown) and a chain (not shown) running along a rail. The chain is provided with a plurality of pins. Additionally, an inside of the tenter device 14 according to this embodiment is divided into a plurality of sections. The temperature of each section is adjusted by the heater described above such that the sections have a temperature different from each other. Thereby, it is possible to dry the wet film 41 gradually due to different temperatures of the respective sections while transporting the wet film 41, thus preventing shrinkage of the wet film 41 caused by rapid evaporation of the solvent. In the tenter device 14, after both side ends of the wet film 41 are shoved into a pin respectively, the wet film 41 is transported along the running of the chain, and the heater promotes the drying of the wet film 41, thus obtaining the film 43. Further, according to this embodiment, a width of the rail is varied to apply tension to the wet film 41 being transported inside the tenter device 14 in a width direction of the wet film 41 such that the wet film 41 is stretched and relaxed. Accordingly, the alignment of molecules of the wet film 41 is controlled to obtain the film 43 having a desired retardation value.

Note that the process for stretching or relaxing the wet film 41 in the width direction can be performed also in the transfer section 13. In this case, in the transfer section 13 and the tenter device 14, at least one of the casting direction and the width direction of the wet film 41 is preferably stretched by 0.5% to 300% relative to the width before stretching. Additionally, while applying tension to the wet film 41 in the transfer section 13 or the tenter device 14, it is preferable to keep the drying temperature of the film at approximately constant. Thereby, it is possible to prevent difference in stretching condition caused by the difference in the drying temperature.

In this embodiment, although the tenter device 14 is a pin-type tenter device provided with a plurality of pins, the present invention is not limited thereto. For example, instead of the pins, a clip-type tenter device provided with a chain having a plurality of holding devices such as clips may be also used. In this case, after holding the both side ends of the wet film 41 by the clips, the drying of the wet film 41 is promoted while being carried along the running of the chain. However, in a case where the dope is cast onto the casting drum 23 whose surface temperature is adjusted to a low value to form a film in a gel-like state as the casting film as in the case of this embodiment, the casting film in a gel-like state is unstable although the casting film in a gel-like state has self-supporting properties. Therefore, since the pins have difficulty in holding the film, it is preferable to use the pin-type tenter device when carrying the wet film with keeping excellent stability.

An edge slitting device 51 having a crusher 50 is disposed in the downstream from the tenter device 14. The edge slitting device 51 cuts both side ends of the fed film 43, thus making it possible to remove the puncture due to the pins and the like at both side ends of the film 43 caused in the tenter device 14 to obtain the film 43 having excellent planarity. Note that the both side ends of the film 43 thus cut away are fed into the crusher 50 and crushed into pieces as chips.

The drying chamber 15 includes a plurality of rollers 53 and an adsorption and recovery device 54. Additionally, a temperature regulator (not shown) adjusts an internal temperature of the drying chamber 15 at a predetermined value. In the drying chamber 15, the drying of the fed film 43 is promoted sufficiently while being carried with the support of each of the rollers 53. In the cooling chamber 16 located in the downstream from the drying chamber 15, the dried film 43 is cooled gradually until the temperature thereof becomes approximately a room temperature. Accordingly, it is possible to prevent wrinkles from being caused by a rapid change in the temperature on a surface of the film 43. Thus the film product having excellent planarity can be obtained.

Further in this embodiment, a compulsory neutralization device (neutralization bar) 56 and a knurling roller 57 are disposed in the downstream side from the cooling chamber 16. Thereby, it is possible to regulate the voltage applied to the film 43 at a predetermined value (for example, in the range of −3 kV to 3 kV). Additionally, by providing knurling, an excellent wrinkle stretching effect can be obtained. The winding chamber 17 includes a winding roller 58 and a press roller 59. Thereby, the press roller 59 applies appropriate pressure to the film 43 whose temperature is adjusted to approximately room temperature in order to stretch wrinkles of the film 43, and the winding roller 58 winds the film 43. Accordingly, it is possible to obtain a roll of film product having excellent planarity.

Note that a preliminary drying chamber (not shown) is preferably disposed between the edge slitting device 51 and the drying chamber 15 to preliminarily dry the film 43 in order to make it possible to obtain an effect of preventing deformation of the film 43 due to the rapid increase in the temperature of film surface in the drying chamber 15 or the like.

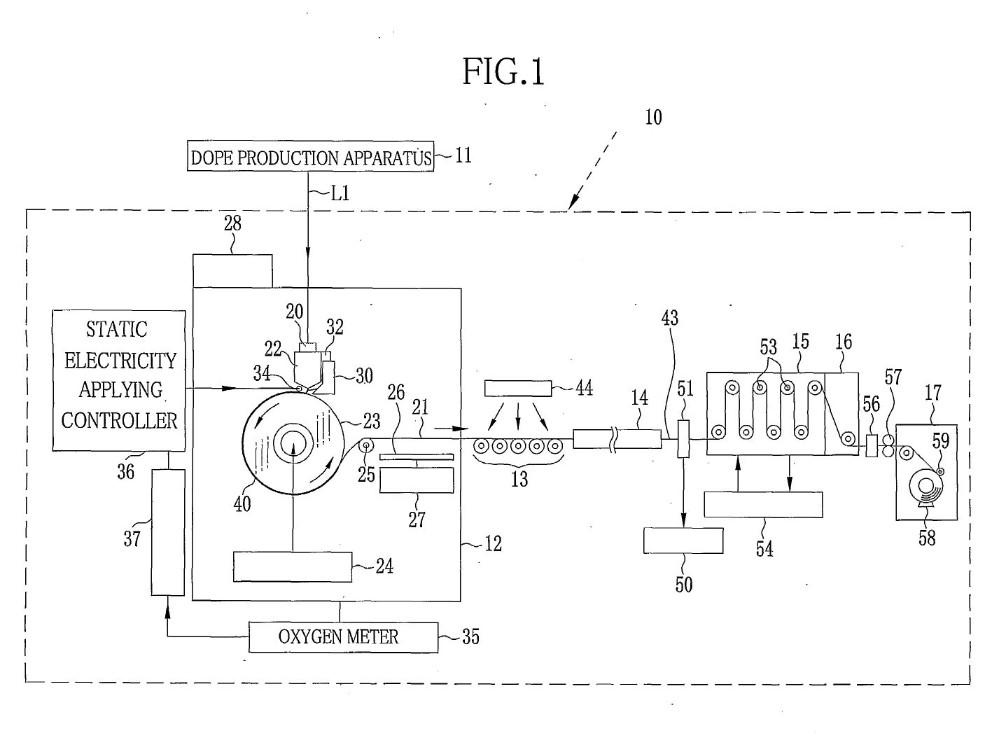

Next, the features of the present invention are described. According to the present invention, in forming the polymer film, in a state where oxygen concentration is set to 0 vol % or more and less than 10 vol %, static electricity is applied between the casting bead and the support, and adhesion device is used to cause the casting bead to adhere to the support. As the adhesion device, it is preferable to use suction means for sucking air and decreasing pressure to decompress a downstream area from of the casting bead. Alternatively, as the adhesion device, it is preferable to use an air knife disposed in the downstream side from a spot where the casting bead reaches the support. Further, it is preferable to use intervening film forming liquid to be supplied between the support and the casting film, thus forming the intervening film for connecting the support and the casting film. Note that, in preparing the intervening film forming liquid, at least a solvent contained in the dope is preferably used. Therefore, in this embodiment, as shown in FIG. 1, the static electricity applying electrode 34 is disposed at the vicinity of the casting bead, and the suction chamber 30 and the intervening film forming device 32 are used as the adhesion device.

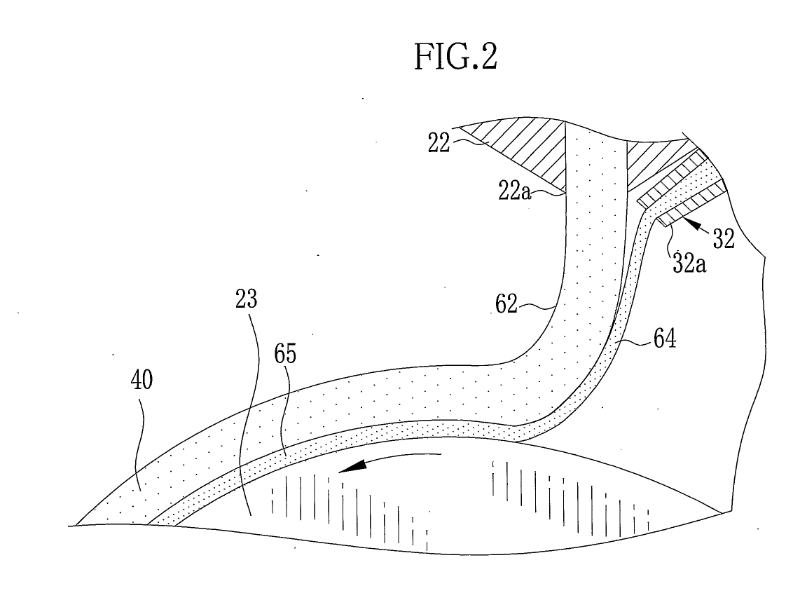

As shown in FIG. 1, the static electricity applying electrode 34 is connected to a static electricity applying controller 36. Note that a static electricity application unit includes the static electricity applying electrode 34 and static electricity applying controller 36. Further, the static electricity applying controller 36 is connected to a controller 37 for controlling the switching on and off of application of the static electricity. In applying static electricity, the static electricity is applied between a casting bead 62 and the casting drum 23 through the static electricity applying electrode 34. As shown in FIG. 2, the casting bead 62 is caused to adhere to the casting drum 23.

The oxygen concentration inside the casting chamber 12 is set to a predetermined value by supplying inert gas such as nitrogen gas and carbon dioxide gas, or supplying mixed gas including inert gas and air. Further, the oxygen meter 35 measures the oxygen concentration inside the casting chamber 12. The measured value of oxygen concentration measured by the oxygen meter 35 is sent to the controller 37. The controller 37 controls the flow rate of the nitrogen gas to be supplied to the casting chamber 12 based on the measured oxygen concentration, for example, such that the oxygen concentration inside the casting chamber 12 is always kept 0 vol % or more and less than 10 vol %. Accordingly, it is possible to prevent fire and explosion due to the solvent vapor in the casting chamber 12 when the static electricity application is performed in the casting chamber 12. In a case where the oxygen concentration becomes equal to or more than 10 vol % for some reasons, an alarm is activated and the measured value is sent to the controller 37 to cause the static electricity applying controller 36 and stop the static electricity application.

The intervening film forming device 32 includes a tank (not shown) for storing an intervening film forming liquid 64, and a channel 32a and a supplying aperture 32b thereof. An adequate amount of the intervening film forming liquid 64 is supplied from the supplying aperture 32a along an entire surface of the casting bead 62 at the side facing the support. The intervening film forming liquid 64 reaches the casting drum 23 to become an intervening film 65 as a liquid film. Thereby, it is possible to prevent occurrence of phenomenon of air entrainment between the casting drum 23 and the casting bead 62. As a result, it becomes possible to form the casting film 40 having excellent planarity and transparency. Note that since the intervening film forming liquid 64 includes a solvent contained in a dope 60, the intervening film 65 diffuses inside the casting film 40 as time advances. Accordingly, the extent of adhesion between the casting drum 23 and the casting film 40 never become too strong. Therefore, since the casting film 40 can be peeled from the casting drum 23 readily by applying a small amount of peeling stress (that is, improvement in the peeling properties is achieved), it becomes possible to reduce hours of work, that is, speed up manufacturing time, and further decrease manufacturing cost by use of energy cost reduction.

The suction chamber 30 includes a jacket (not shown) capable of keeping the internal temperature at a predetermined value. While the dope 60 is cast, the suction chamber 30 decompresses the downstream area from the casting bead 62 to a predetermined value. The degree of the suction is preferably in the range of (atmosphere pressure—2000 Pa) to (atmosphere pressure—10 Pa) Thereby, air flow around the casting bead 62 moderates, and occurrence of the phenomenon of air entrainment relative to the casting bead 62 is prevented, so that the casting bead 62 is adequately pulled backward. As a result, it is possible to form the casting bead 62 having amore stable shape. Note that although the internal temperature of the casting chamber 30 is not especially limited, it is preferable that the internal temperature of the casting chamber 30 is equal to or more than a condensation temperature of a solvent to be used for the purpose of promoting the drying of the casting film 40. In order to keep the desirable shape of the casting bead, it is preferable to provide an edge portion of the casting die 22 with a suction device (not shown) to suck the edge portion such that the volume of sucked air is in the range of 1 L/min to 100 L/min.

As described above, in this embodiment, in casting the dope 60 onto the casting drum 23, the oxygen concentration within the casting chamber 12 is set to 0 vol % or more and less than 10 vol %, the static electricity applying electrode 34 applies static electricity between the casting drum 23 and the casting bead 62, and the suction chamber 30 decompresses the downstream area from the casting bead 62, at the same time as the intervening film forming liquid 64 is supplied along the entire surface of the casting bead 62 at the side facing the support. Thereby, it is possible to reduce possibility of fire or explosion and form the casting bead 62 having a stable shape as well as enhance the extent of the adhesion between the casting drum 23 and the casting bead 62. Note that the suction chamber 30 decompresses the downstream area from the casting bead 62 to form the casting bead 62 having a more stable shape. As a result, even if the film forming speed is made faster, the casting film 40 having no wrinkles and excellent planarity can be obtained.

Note that the intervening film forming liquid 64 may be supplied to the entire surface of the casting bead 62 or supplied to only both side ends of the casting bead 62. In this embodiment, the intervening film forming liquid 64 is supplied to the entire surface of the casting bead 62. This embodiment is preferable since excellent result can be obtained with respect to prevention of phenomenon of air entrainment and the peeling properties, in comparison with a case where the intervening film forming liquid 64 is supplied only both side ends of the casting bead 62.

Note that although the intervening film forming liquid 64 is supplied along the casting bead 62 in this embodiment, the supplying method is not limited thereto. For example, when a position where the bead reaches the support on the peripheral surface of the casting drum 23 is referred to as an arrival position, the intervening film forming liquid 64 may be supplied to the upstream side of the peripheral surface of the casting drum 23 to form the intervening film ahead of the casting film.

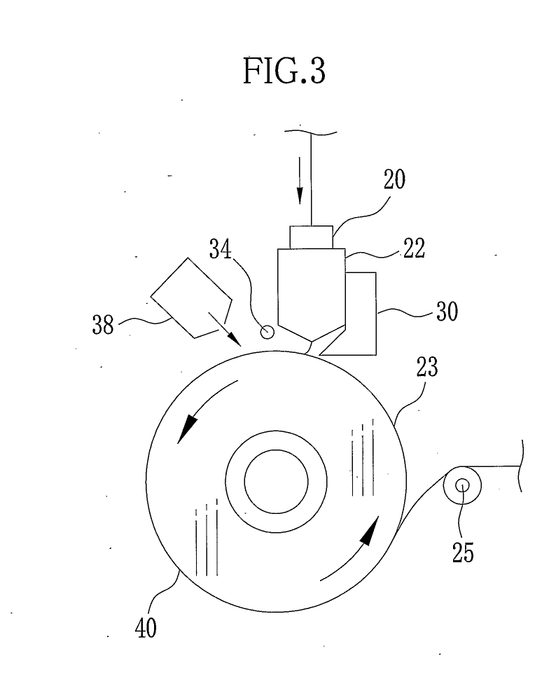

Further, as the adhesion device for causing the casting bead and the support to adhere to each other, the suction chamber and the intervening film forming device are used in this embodiment. However, as shown in FIG. 3, the air knife 38 disposed in the downstream side from a position where the casting bead 62 reaches the casting drum 23 may be used as the adhesion device. Thereafter, air is blown against the casting bead 62 at the side not facing the support while applying static electricity thereto by use of the static electricity applying electrode 34. Then, the extent of the adhesion between the casting drum 23 and the casting bead 26 is enhanced while forming the casting bead 62 having a stable shape, thus making it possible to obtain the casting film 40.

Next, a procedure of forming the film 43 by use of the dope production apparatus 10 is described. Firstly, the dope 60 is preliminarily produced by use of a dope production apparatus 11. An adequate amount of the dope 60 is sent to a feed block 20 in the casting chamber 12 through a liquid supply line L1.

After the dope 60 is fed into the casting die 22 from the feed block 20, the dope 60 is cast onto the casting drum 23 from a casting aperture 22a while forming the casting bead 62 as shown in FIG. 2. At this time, in a state where the oxygen concentration inside the casting chamber 12 is set to 0 vol % or more and less than 10 vol %, static electricity applying electrode 34 is activated to apply static electricity between the casting drum 23 and the casting bead 62. Further, the suction chamber 30 decompresses the downstream area from the casting bead 62, and the intervening film forming device 32 supplies an adequate amount of the intervening film forming liquid 64 along the entire surface of the casting bead 62 at the side facing the support. Thereafter, the casting bead 62 is caused to adhere to the casting drum 23 tightly, and the casting film 40 is formed onto the casting drum 23 in a short time of period while preventing occurrence of phenomenon of air entrainment between the casting drum 23 and the casting bead 62.

The temperature of the dope 60 to be cast is preferably adjusted to −10° C. to 55° C. The casting amount of the dope 60 is preferably regulated such that the thickness of the polymer film after being dried remains approximately constant in the range of 20 μm to 500 μm. Accordingly, the dope 60 is cooled and turned into a gel-like state on the casting drum 23 whose temperature is adjusted to a predetermined value in a short time of period to obtain the casting film 40. Note that the thickness of the casting film 40 is preferably regulated such that the thickness of the polymer film after being dried is in the range of 20 μm to 150 μm, more preferably in the range of 25 μm to 100 μm.

A cooling medium whose temperature is adjusted to a predetermined value is supplied from the cooling medium feeder 24 to the channel formed inside the casting drum 23 such that the surface temperature of the casting drum 23 is in the range of −40° C. to 30° C. Accordingly, the dope 60 cast onto the casting drum 23 is cooled to obtain the casting film 40 in a gel-like state. Note that variation in speed of the casting drum 23 is equal to or less than 3%. The variation in location in a vertical direction of the casting drum 23 just below the casting die 22 is adjusted so as to be equal to or less than 500 μm in order to form the casting bead 62 having a stable shape and the casting film 40 having excellent planarity. The internal temperature of the casting chamber 12 is regulated so as to be approximately constant in the range of −10° C. to 57° C. by the temperature regulator 28. After the solvent vapor in the casting chamber 12 is condensed and liquidized by the condenser 26 to be recovered by the recovery device 27, the resultant is refined by a refining device (not shown) to be reused as the solvent for preparing the dope.

Next, the casting film 40 is peeled from the casting drum 23 to form the wet film 41. Note that a residual amount of the solvent in the wet film 41 just after being formed is in the range of 10 mass % to 200 mass % based on the solid content. Thereafter, the wet film 41 is sent to the transfer section 13 through the peel roller 25. In the transfer section 13, a dry air adjusted to a predetermined temperature is blown against the wet film 41 from the drying device 44 while the wet film 41 is transported by the support of each of the rollers, thus promoting the drying of the wet film 41. Note that the temperature of the dry air supplied from the drying device 44 is preferably approximately constant in the range of 20° C. to 250° C., however, maybe arbitrarily determined in the above range in consideration of kinds of materials such as a polymer, an additive, and the like to be used for the dope 60, or manufacturing speed.

Note that in the transfer section 13, the rotation speed of each of the rollers disposed in the downstream side, namely, at the vicinity of an outlet of the transfer section 13 is preferably made faster than that of each of the rollers disposed in the upstream side (namely, inlet side of the transfer section 13), among the plurality of rollers to be disposed in the transfer section 13. Thereby, it becomes possible to transfer the wet film 41 in the transfer section 13 while applying appropriate tensile force thereto without causing wrinkles. In addition to this, it becomes easy to control the retardation value by applying tensile force to the wet film 41 containing large residual amount of the solvent.

The wet film 41 is fed into the tenter device 14 located in the downstream side from the transfer section 13. In the tenter device 14, after both side ends of the wet film 41 are respectively shoved into a plurality of pins attached to the chain running endlessly and fixed thereto, the wet film 41 is transported along the running of the chain. At this time, the heater (not shown) heats the wet film 41 to promote drying of the same, thus obtaining the film 43. Note that, in the tenter device 14, it is preferable that the wet film 41 to be transported is stretched in the width direction thereof to regulate the retardation value of the film 43 to be formed at a desirable value.

The film 43 is fed into the edge slitting device 51 and the both side ends thereof are cut off. Note that, although the process for cutting off the both side ends of the film 43 may be omitted, the process is preferably performed in any one of portions located between the casting chamber 12 and the winding chamber 17. As in the case of this embodiment, under the condition that the edge slitting device 51 is disposed in the downstream side from the tenter device 14 for the cutting process, it is possible to cut off the both side ends of the film 43 having the puncture due to the pins and the like to obtain the film 43 having excellent planarity.

Thereafter, the film 43 is fed into the drying chamber 15, and the drying thereof is sufficiently promoted while being transported by the support of the plurality of rollers 53. The internal temperature of the drying chamber 15 is not especially limited, however, it is preferable that the temperature of the film 43 is adjusted to be in the range of 60° C. to 145° C., because under such a condition the solvent can be efficiently volatilized while preventing the polymer constituting the film 43 from being damaged by heat. Further, in this embodiment, the solvent in the film 43 is evaporated such that solvent vapor exists in the drying chamber 15. After the gas containing the solvent vapor is recovered by the adsorption and recovery device 54 and the solvent component is removed, the gas is sent to the drying chamber 15 again as dry air. Thereby, the energy cost can be reduced, thus decreasing the manufacturing cost.

The film 43 after being dried is fed into the cooling chamber 16 and cooled to be approximately room temperature. Note that a humidity control chamber (not shown) is preferably disposed between the drying chamber 15 and the cooling chamber 16. After the humidity control chamber controls the humidity of the film 43, the film 43 is preferably fed into the cooling chamber 16. As a result, it is possible to achieve excellent wrinkle smoothing effect on the surface of the film 43.

The film 43 is fed into the compulsory neutralization device 56 and the voltage applied thereto is regulated in a predetermined range (for example, in the range of −3 kV to 3 kV). Note that, although the compulsory neutralization device 56 is located in the downstream side from the cooling chamber 16 in FIG. 1, the present invention is not limited thereto. The both side ends of the film 43 are embossed by the knurling roller 57 for knurling.

Lastly, in the winding chamber 17, the film 43 is wound by the winding roller 58 while the press roller 59 adjusts the tensile force at the time of winding, thus producing a roll of film product. The tensile force at the time of winding is preferably gradually changed during the winding operation. The length of the film 43 to be wound is preferably at least 100 m or more in the feeding direction thereof, and 1400 mm to 1800 mm in the width direction thereof. However, in the present invention, even if the length of the film 43 is more than 1800 mm, it is possible to achieve effective result.

Note that the thickness of the obtained film 43 is preferably in the range of 20 μm to 500 μm, more preferably in the range of 30 μm to 300 μm, most preferably in the range of 35 μm to 200 μm. However, the thickness of the obtained film 43 is not especially limited in the present invention. That is, even if the thickness of the film 43 is as thin as 15 μm to 100 μm, it is possible to achieve effective result.

Note that, according to the present invention, as for the residual amount of the solvent, the solvent is main solvent contained in the film (including the casting film and the wet film) as a target. However, when various solvents are contained in the film as the target, the solvent whose amount is greatest in the film is regarded as the main solvent. The residual amount of the solvent is determined on a dry basis, and a value calculated by a formula: [(x−y)/y]×100, in which x is weight of the film at the time of sampling and y is weight of the sampling film after being dried completely.

Various materials used for preparing the dope in the present invention are hereinafter described.

The polymer in the present invention may be any known polymer as far as a dope can be produced by use of the polymer and is not especially limited. In this embodiment, polymer is cellulose acylate, and cellulose acylate is especially preferably triacetyl cellulose (TAC). In cellulose acylate, it is preferable that the degree of the acyl substitution for hydrogen atoms in hydroxyl groups in cellulose satisfies all of the following formulae:

2.5≦A+B≦3.0 (a)

0≦A≦3.0 (b)

0≦B≦2.9 (c)

In the above formulae (a) to (c), the A represents a degree of substitution of the hydrogen atom in the hydroxyl group to the acetyl group in cellulose, while the B represents a degree of substitution of the hydrogen atom in the hydroxyl group to the acyl group with 3 to 22 carbon atoms in cellulose. Preferably, at least 90 mass % of TAC particles have a diameter in the range of 0.1 mm to 4 mm, respectively. However, the polymer to be used in the present invention is not limited to cellulose acylate.

Cellulose has glucose units making β-1,4 bond, and each glucose unit has a liberated hydroxyl group at second, third, and sixth positions. Cellulose acylate is a polymer in which a part of or the whole of the hydroxyl groups are esterified so that the hydrogen is substituted by the acyl group with two or more carbons. The degree of substitution for the acyl groups in cellulose acylate means a degree of esterification of the hydroxyl group at each of the second, the third, and the sixth positions in cellulose (when the whole (100%) of the hydroxyl group at the same position is substituted, the degree of substitution at this position is 1).

The total degree of substitution for the acyl groups, namely DS2+DS3+DS6, is preferably in the range of 2.00 to 3.00, more preferably in the range of 2.22 to 2.90, and most preferably in the range of 2.40 to 2.88. In addition, DS6/(DS2+DS3+DS6) is preferably at least 0.28, more preferably at least 0.30, and most preferably in the range of 0.31 to 0.34. Note that DS2 is the degree of substitution of the hydrogen atom in the hydroxyl group at second position per glucose unit to the acyl group (hereinafter referred to as a degree of acyl substitution at second position), DS3 is the degree of substitution of the hydrogen atom in the hydroxyl group at third position per glucose unit to the acyl group (hereinafter referred to as a degree of acyl substitution at third position), and DS6 is the degree of substitution of the hydrogen atom in the hydroxyl group at sixth position per glucose unit to the acyl group (hereinafter referred to as a degree of acyl substitution at sixth position).

In the present invention, the kind of the acyl groups in cellulose acylate can be one or more. When two or more kinds of acyl groups are in cellulose acylate, it is preferable that one of them is the acetyl group. When a total degree of substitution of the hydroxyl group at the second, the third, and the sixth positions to the acetyl groups and that to acyl groups other than acetyl groups are described as DSA and DSB, respectively, the value of DSA+DSB is preferably in the range of 2.22 to 2.90, and more preferably in the range of 2.40 to 2.88.

In addition, DSB is preferably at least 0.30, and more preferably at least 0.7. In the DSB, the percentage of the substitution of the hydroxyl group at the sixth position is at least 20%. The percentage is preferably at least 25%, more preferably at least 30%, and most preferably at least 33%. Furthermore, the value of DSA+DSB, in which the hydroxyl group is at the sixth position in cellulose acylate, is preferably at least 0.75, more preferably at least 0.80, and most preferably at least 0.85. By using such cellulose acylate that satisfies the above conditions, a solution (dope) with excellent solubility can be prepared. Especially, since using a non-chlorine organic solvent represents excellent solubility, it is possible to produce the dope with low viscosity and excellent filterability.

Although cellulose as a material of cellulose acylate may be obtained from either linter cotton or pulp cotton, the linter cotton is preferably used.

According to the present invention, as for cellulose acylate, the acyl group having at least 2 carbon atoms may be either aliphatic group or aryl group, and is not especially limited. As examples of the cellulose acylate, there are alkylcarbonyl ester, alkenylcarbonyl ester, aromatic carbonyl ester, aromatic alkylcalbonyl ester, and the like. Cellulose acylate may be also esters having other substituents. Preferable substituents are, for example, propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group, and the like. Among them, more preferable groups are propionyl group, butanoyl group, dodecanoyl group, octadecanoyl group, t-butanoyl group, oleoyl group, benzoyl group, naphtyl carbonyl group, cinnamoyl group, and the like. Particularly, propionyl group and butanoyl group are most preferable.

According to the present invention, the solvent to be used for preparing the dope is preferably a compound that can dissolve polymer. As such a solvent, there are aromatic hydrocarbon (for example, benzene, toluene, and the like), halogenated hydrocarbon (for example, dichloromethane, chloroform, chlorobenzene, and the like), alcohol (for example, methanol, ethanol, n-propanol, n-butanol, diethylene glycol, and the like), ketone (for example, acetone, methylethyl ketone, and the like), ester (for example, methylacetate, ethylacetate, propylacetate, and the like), ether (for example, tetrahydrofuran, methylcellosolve, and the like), and the like. Note that in the present invention the dope means a polymer solution or dispersion solution that is obtained by dissolving or dispersing the polymer in the solvent.

The solvent is preferably hydrophobic, and the hydrophobic solvent is most preferably dichloromethane. The halogenated hydrocarbon preferably has 1 to 7 carbon atoms. In view of physical properties of the cellulose acylate, such as solubility, peelability from the support of the casting film, a mechanical strength of the film, and optical properties, it is preferable to use at least one kind of alcohol having 1 to 5 carbon atoms together with dichloromethane. The content of alcohol is preferably in the range of 2 mass % to 25 mass %, and more preferably in the range of 5 mass % to 20 mass % relative to the whole solvent. Applicable alcohols are, for example, methanol, ethanol, n-propanol, iso-propanol, n-butanol, and the like, and especially methanol, ethanol, n-butanol, and a mixture of them are more preferable among them. Note that according to the present invention the intervening film forming liquid is preferably prepared with use of the solvent for preparing the dope described above.

Recently, in order to reduce adverse influence on the environment, a solvent containing no dichloromethane is proposed. In this case, the solvent preferably contains ether with 4 to 12 carbon atoms, ketone with 3 to 12 carbon atoms, ester with 3 to 12 carbon atoms, or a mixture of them. Note that ether, ketone, and esther may have a cyclic structure, and a compound having at least two functional groups thereof (that is, —O—, —CO—, and —COO—) may be used as the organic solvent. The organic solvent may have other functional groups such as alcoholic hydroxyl groups. In using the organic solvent having two or more functional groups, the number of carbon atoms should be within a regulation range of the compound having one of the functional groups, however the number is not especially limited.

Note that fine particles are silicon dioxide derivatives including silicone resin of silicon dioxide having three-dimensional web formation. As described above, when fine particles are silicon dioxide derivatives and their surfaces are subjected to an alkylation process serving as a hydrophobic treatment, excellent dispersibility to the solvent can be achieved. Accordingly, since it is possible to produce the film while suppressing aggregation of the fine particles, the produced film has few surface defects as well as has excellent transparency.

Note that each of the alkyl groups introduced into the surface of the fine particles subjected to the alkylation process has 1 to 20 carbon atoms, more preferably 1 to 12 carbon atoms, and most preferably 1 to 8 carbon atoms. With use of such fine particles containing the alkyl groups, it is possible to suppress aggregation of the fine particles and improve dispersibility thereof. As describe above, the fine particles whose surfaces have the alkyl groups with 1 to 20 carbon atoms respectively can be obtained by processing silicon dioxide fine particles with use of octylsilane. Additionally, as an example of silicon dioxide derivative whose surface have octyl group respectively, AEROSIL R805 (manufactured by NIPPON AEROSIL CO., LTD.) is available commercially. AEROSIL is preferably applicable in the present invention.

The content of the fine particles in the dope based on the solid content is set to 0.2% or less. Note that, the content of the fine particles is prepared after deciding the amount of fine particles to be added to the solvent such that the above range is satisfied in preparing the dope. In such a dope prepared by adding the fine particles while its content is controlled, it is possible to suppress occurrence of foreign substances due to the aggregation of the fine particles. Accordingly it is possible to produce the film providing optical properties such as excellent transparency or the like. The average diameter of the fine particles is preferably equal to or less than 1.0 μm, more preferably 0.3 μm to 1.0 μm, most preferably 0.4 μm to 0.8 μm.

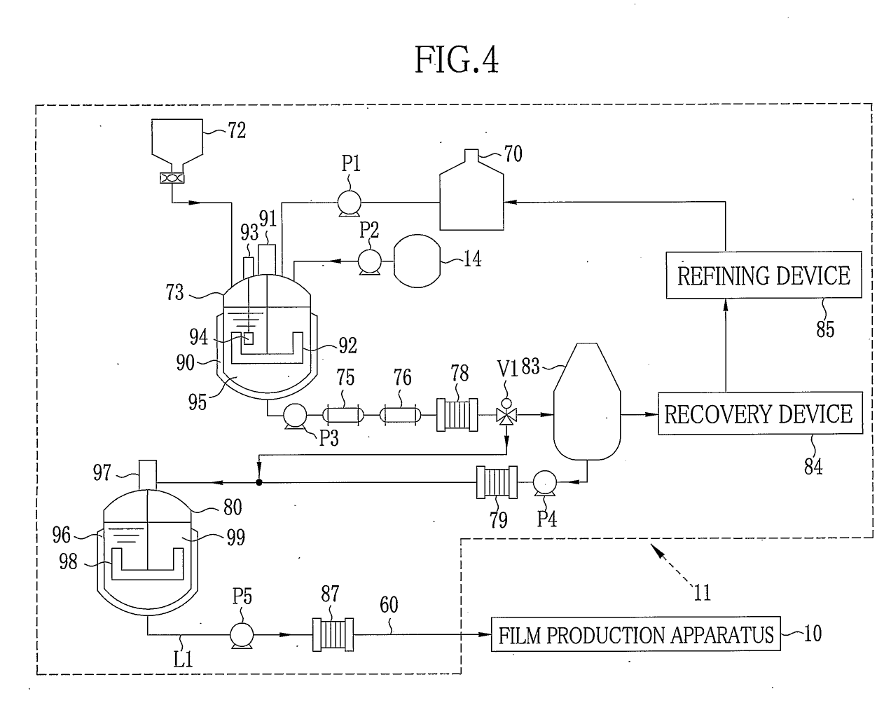

According to the present invention, a method for preparing a dope is explained. FIG. 4 is a schematic diagram of the dope production apparatus 11 according to an embodiment of the present invention.

The dope production apparatus 11 includes a first tank 70, a second tank 71, a hopper 72, a dissolving tank 73, a heater 75, a temperature regulator 76, a first filtration device 78, a second filtration device 79, and a stock tank 80, in addition to a flash device 83, a recovery device 84, a refining device 85, and a third filtration device 87. Each device and member is connected together with use of stainless pipes in view of resistance to corrosion and resistance to heat of the pipes. Pumps P1 to P5 and a bulb V1 are attached to adequate spots of respective pipes. Note that the number, the location, and the like of the pumps and the bulb can be varied if necessary. Therefore, the present invention is not limited to this embodiment.

The first tank 70 stores the solvent for the dope 60. The second tank 71 stores liquid containing a predetermined additive and fine particles to be used in the dope 60. The hopper 72 stores TAC serving as a polymer that is a material of the film.

The dissolving tank 73 is provided with a jacket 90 for covering an outer surface thereof, a first stirrer 92 rotated by a motor 91, and a second stirrer 94 rotated by a motor 93. Preferably, the first stirrer 92 has an anchor blade, and the second stirrer 94 is a decentering stirrer of dissolver type. The internal temperature of the dissolving tank 73 is controlled by regulating the temperature of a heat transfer medium flowing inside the jacket 90. A preferable temperature range of the dissolving tank 73 is −10° C. to 55° C. In the dissolving tank 73, the first stirrer 92 and the second stirrer 94 are arbitrarily selected and rotated to mix the solvent fed into the dissolving tank 73, TAC, the additive, and the like together, thus preparing a mixture 95.

The heater 75 is preferably a pipe provided with a jacket capable of controlling a temperature. Thereby, the mixture 95 is heated to promote dissolution of the solid contents. Note that the temperature for heating the mixture 95 by the heater 75 is preferably in the range of 0° C. to 97° C. such that various materials contained in the mixture 95 are not damaged by the heat. Accordingly, according to the present invention, it means that the mixture 95 is not heated to more than a room temperature by the heater 75, and that the mixture 95 sent from the dissolving tank 73 is heated by the heater 75. For example, when the temperature of the mixture 95 sent from the dissolving tank 73 is −7° C., there is a case where the temperature thereof is heated to 0° C. Further, the heater 75 is preferably provided with a pressurizing means for pressurizing the mixture 95. Thereby, it is possible to improve solubility of TAC to the solvent by pressurizing the mixture 95.

Note that instead of the heat-dissolving method by the heater 75, it is possible to perform a cool-dissolving method. In the cool-dissolving method, the mixture 95 serving as a swelling liquid is cooled to promote dissolution. At this time, it is known that the mixture 95 should be cooled to −100° C. to −10° C. The above-described heat-dissolving method and the cool-dissolving method are arbitrarily selected based on the properties of the various materials and performed, thus making it possible to control-the solubility of the mixture 95.

The temperature regulator 76 is a device to regulate the temperature of the mixture 95 to approximately a room temperature, thus obtaining a polymer solution 99 in which TAC is dissolved into the solvent. Note that a solution after going out of the temperature regulator 76 is referred to as the polymer solution, however there is often a case where TAC has already been dissolved into the solvent at the time of going out of the temperature regulator 76. Therefore, in the present invention, the solution in which the polymer is dissolved into the solvent is referred to as the polymer solution 99.

Each of the first and second filtration devices 78 and 79 is provided with a filter having pores whose diameter each is a desired value. The average diameter of pores of the filter is preferably equal to or less than 100 μm such that even small foreign substances can be removed from the polymer solution 99. Note that the third filtration device 87 may be the same as these filtration devices. However, when the average diameter of the pores of the filter is too small, it takes a long time for filtration. Therefore, the time required for preparing the dope also becomes long. In contrast, when the average diameter of the pores of the filter is too large, it becomes impossible to remove the small foreign substances. Accordingly, although the average diameter of the pores of the filter is not especially limited, it is preferable that the average diameter is arbitrarily selected based on the manufacturing time or the like. The polymer solution 99 fed into the first filtration device 78 is filtered to remove the foreign substances. At this time, the filtering flow rate is preferably equal to or more than 50 L/h. Thereby, it is possible to proceed the operation without spending so much time on the filtration. Thereafter, the polymer solution 99 after removing the foreign substances is fed into the stock tank 80.

The stock tank 80 is provided with a jacket 96 for covering an outer surface thereof, and a stirrer 98 rotated by a motor 97. As in the case of the dissolving tank 73, in the stock tank 80, a heat transfer medium whose temperature is regulated to a predetermined value is supplied to the jacket 96 to arbitrarily regulate the inner temperature thereof. Further, the stirrer 98 is always rotated such that the polymer solution 99 is stored in a constant state while suppressing aggregation of the foreign substances. Note that the stock tank 80 is connected to the film production apparatus 10 through the liquid supply line L1. The polymer solution 99 retained constantly in the stock tank 80 is arbitrarily sent to the liquid supply line L1 if necessary. At this time, the flow rate of the polymer solution 99 to be sent to the liquid supply line L1 is regulated by the pump P5, and the polymer solution 99 is filtered by the third filtration device 87. Thereafter the polymer solution 99 is sent as the dope 60 to a film production apparatus 10.

However, as described above, the method for preparing the polymer solution 99 after producing the mixture 95 takes longer time when the concentration of the polymer solution 99 to be produced is higher. Therefore, there arises a problem in that the manufacturing cost increases, or the like. In view of this, in order to avoid the problem, it is preferable that the polymer solution 99 having a concentration lower than a desired concentration is prepared and then concentrated to have a desired concentration. In this method, at first, according to the above-described procedure, the polymer 99 having a concentration lower than the desired concentration is prepared. Thereafter, the polymer solution 99 is filtered in the first filtration device 78, fed into the flash device 83 through the bulb V2, and part of the solvent contained in the polymer solution 99 is evaporated. Thereby, it is possible to concentrate the polymer solution 99 such that the concentration thereof becomes a desired value. Note that the solvent gas generated due to the evaporation is condensed and liquidized by a condenser (not shown) to be recovered by the recovery device 84, and the resultant is refined by the refining device 85. The solvent thus refined is used to prepare the mixture 95, thus making it possible to achieve excellent effects including reduction in cost of the materials.

The polymer solution 99 thus concentrated is taken out of the flash device 83 by the pump P3, and then fed into the second filtration device 79 to be filtrated, thus removing the foreign substances. Thereafter, the polymer solution 99 is fed into the stock tank 83 and always stirred by rotation of the stirrer 98, thus being stored in the stock tank 83. Further, when the polymer solution 99 is to be taken out of the flash device 83, it is preferable that a defoaming process is performed in order to removing the bubbles contained in the polymer solution 99. As the deforming process, various well-known methods are applicable. For example, there is an ultrasonic irradiation method. Note that the temperature of the polymer solution 99 at the time of being filtered in the second filtration device 79 is preferably in the range of 0° C. to 200° C.

Next, a dope production method with use of the dope production apparatus 10 is explained.

At first, a predetermined amount of solvent is supplied to the dissolving tank 73 from the first tank 70 while regulating the flow rate by the pump P1. At this time, an additive liquid is supplied to the dissolving tank 73 from the second tank 71 while regulating the flow rate thereof by a pump P2. Additionally, a desired amount of TAC is supplied to the dissolving tank 73 from the hopper 72. Note that in the second tank 71 there is stored an additive liquid in which the additive and fine particles are preliminarily dissolved into the predetermined amount of the solvent (that is, in a solution state) or an additive liquid in which the additive and fine particles are dispersed (that is, in a dispersion state). The solvent for dissolving or dispersing the additive and fine particles is preferably the same as one stored in the first tank 70 in a normal case, however the solvent may be arbitrarily varied based on the kind of the additive.

After the various materials are fed into the dissolving tank 73, the internal temperature of the dissolving tank 73 is regulated so as to be in the range of −10° C. to 55° C. by regulating the temperature of the heat transfer medium flowing in the jacket 90. At the same time, the first and second stirrers 92 and 94 are arbitrarily selected and rotated to prepare the mixture 95 in which the various materials are mixed together.

The prepared mixture 95 is fed into the heater 75 by a pump P3 to promote the dissolution of the solid content in the mixture 95 as a swelling liquid. In this embodiment the heater 75 is a pipe having a jacket capable of controlling the temperature such that heating temperature is in the range of 0° C. to 97° C. and a pressurizing means to pressurize the mixture 95, thus improving the solubility of the solid content to the solvent.

The temperature of the mixture 95 is regulated to approximately room temperature by the temperature regulator 76 to obtain the polymer solution 99 in which the polymer is dissolved into the solvent. Next, the polymer solution 99 is caused to pass the first filtration device 78 provided with a filter having pores each of which average diameter is 100 pm or less to remove foreign substances. Thereafter, by opening/closing the bulb V1, the polymer solution 99 is fed into the flash device 85 and concentrated to a predetermined concentration. Then, the polymer solution 99 thus concentrated is taken out of the flash device 83 by a pump P4, and fed into the second filtration device 79 to be filtered, thus further removing foreign substances. Note that the filtering flow rate in the first and second filtration devices 78 and 79 is regulated to 50 L/h or more. The polymer solution 99 having desired concentration after removing the foreign substances is fed into the stock tank 80 and stored therein.

In the stock tank 80, the stirrer 98 is always rotated while regulating the temperature thereof by controlling the temperature of the heat transfer medium to be supplied to the jacket 96, thus retaining the polymer solution 99 in a constant state. Thereafter, if necessary, an adequate amount of the polymer solution 99 is arbitrarily sent to the liquid supply line L1 and further fed into the third filtration device 87 by a pump P5 to be filtrated, thus obtaining the dope 60. Then, the dope 60 is fed into the film production apparatus 10.

Note that in this embodiment the additive liquid in which the additive is preliminarily mixed into the solvent is used. However, in a case where an additive is solid, instead of the second tank 71, the hopper or the like is used to supply the additive to the dissolving tank 73. Further, in a case where plural kinds of additives are to be added, a solution in which each of the additives is preliminarily dissolved into the solvent may be prepared and sent from the second tank 71 to the dissolving tank 73. Alternatively, it is possible that plural tanks are prepared in accordance with the kinds of the solutions containing each additive, and each of the tanks and the dissolving tank 73 are connected to each other through a liquid supply line, thus supplying the additives to the dissolving tank 73. Further, in a case where the additive is liquid at room temperature, it is possible to send the additive to the dissolving tank 73 without using the solvent.

In this embodiment, although the solvent, TAC, and the additive as the materials for the dope are sent to the dissolving tank 73 in this order, the order is not limited thereto. For example, the order may be TAC, the solvent, and the additive. Further the additive may not be mixed together with the materials for the dope in the dissolving tank 73. In a case where the additive with small molecular weight is easily vaporized, or in other cases, the additive may be arbitrarily added. For example, the additive may be added in a process after the heating process, in accordance with its kind, properties, or the like.

In a case where the polymer for preparing the dope 60 is triacetyl cellulose (TAC), the concentration of TAC in the polymer solution 99 is preferably in the range of 5 mass % to 40 mass %, more preferably in the range of 15 mass % to 30 mass %, and most preferably in the range of 17 mass % to 25 mass %. Additionally, the concentration of the additive (mainly a plasticizer) is preferably in the range of 1 mass % to 20 mass % relative to the whole solid content in the polymer solution 99. A method for producing a dope for casting by use of such a solution film forming method for producing a TAC film (for example, a dissolving method and an adding method of materials and additives, a filtration method, deforming, and the like) is described in detail in paragraphs [0517] to [0616] of Japanese Patent Laid-Open Publication No. 2005-104148. The description is also applicable to the present invention.

A description about cellulose acylate is described in paragraphs [0140] to [0195] in Japanese Patent Laid-Open Publication No. 2005-104148. The description is also applicable to the present invention. Further, a detailed description about the solvents and the additives (such as a plasticizer, a deterioration inhibitor, a UV-absorbing agent, an optical anisotropy controller, a retardation controller, dye, a matting agent, a release agent, a release promoting agent, and the like) is also described in paragraphs [0196] to [0516] in the same publication. The description is also applicable to the present invention.

In this embodiment, a single layer casting method utilizing one kind of the dope is used to produce a film including a single layer, however the present invention is not limited thereto. It is also possible to produce a film including plural layers which has a main layer and surface layers sandwiching the main layer. Note that it means that a first surface layer and a second surface layer sandwich the main layer serving as a main stream. In this case, after plural kinds of dopes for forming main layer and surface layers are preliminarily prepared, these plural kinds of dopes may be co-cast to form a casting film. In such a co-casting method, after two or more kinds of dopes are supplied to the feed block or the casting die provided with flow channels for achieving a desired layer structure, these two or more kinds of dopes may be co-cast at the same time. Alternatively, the casting dies for supplying the dopes for the surface layers and the main layer respectively may be disposed, and these dopes for casting may be sequentially co-cast onto the running support. Further, these both co-casting methods may be combined.

When the co-casting methods are performed at the same time, the casting die provided with the feed block may be used, or a multi-manifold type casting die may be used. As for the film including multiple layers obtained by the co-casting, at least one of the thickness of the layer on the air surface side and the thickness of the layer on the support side is preferably in the range of 0.5% to 30% relative to the total thickness of the film. Further, the dope with high viscosity is preferably wrapped with the dope with low viscosity in casting the dope from the die slit onto the support. Further, as for the casting bead from the die slit to the support, it is preferable that the dope exposed to the outside has composition ratio of alcohol larger than that of the inner dope.

It is preferable that the viscosity (Pa·s) of the dope for the surface layers is adjusted to 40 Pa·s or less. Thereby, since the surface layers dry faster than the main layer located inside, it is possible to obtain an effect for protecting the main layer. The inner portion of the main layer protected by the surface layers gradually dries so that the bubbling of the solvent can be suppressed. Therefore, it becomes possible to form the casting film 40 having excellent planarity and capable of decreasing defects such as bubbling or the like. However, when the viscosity of the dope for the surface layers is larger than 40 Pa·s, unevenness tends to occur on the surface of the casting film 40 due to the high viscosity, unfavorably. Further, the manufacturing time becomes longer unfavorably, since the casting speed becomes slow.

A detailed description about the casting die, the suction chamber, a structure of the support or the like, co-casting, the peeling method, stretching, the drying condition in each process, the handling method, curling, the winding method after correcting planarity, the solvent recovering method, and the film recovering method is described in paragraphs [0617] to [0889] in Japanese Patent Laid-Open Publication No. 2005-104148. The description is also applicable to the present invention.

### Properties and Measuring Method

### Degree of Curling and Thickness

The properties of the cellulose acylate film wound up and the measuring method thereof are described in paragraphs [1073] to [1087] in Japanese Patent Laid-Open Publication No. 2005-104148. The description is also applicable to the present invention.

### Surface Treatment

At least one of the surfaces of the cellulose acylate film is preferably subjected to a surface treatment. The surface treatment is preferably at least one of vacuum glow discharge, plasma discharge under the atmospheric pressure, UV-light irradiation, corona discharge, flame treatment, acid treatment, and alkali treatment.

### Functional Layer

### Antistatic, Hardened Layer, Antireflection, Easily adhesion, and Antiglare Function

At least one of the surfaces of the cellulose acylate film may be subjected to an undercoating process.

It is preferable that the cellulose acylate film is the base film and used as a functional material including other functional layers. As the functional layer, it is preferable that there is provided one of an antistatic layer, a hardened resin layer, antireflection layer, an easily adhesive layer, an antiglare layer, and an optical compensation layer. The functional layer preferably contains at least one kind of each of surfactants, lubricants, and matting agents in the range of 0.1 mg/m² to 1000 mg/m² each. More preferably, the functional layer contains at least one kind of antistatic agents in the range of 1 mg/m² to 1000 mg/ m². Note that, other than the above, a method of forming the surface treatment functional layer for providing the cellulose acylate film with various functions and properties, detailed conditions thereof, and detailed methods are described in paragraphs [0890] to [1072] in Japanese Patent Laid-Open Publication No. 2005-104148. The description is also applicable to the present invention.

Applications of the film obtained according to the present invention are described hereinafter. The film obtained according to the present invention has a high retardation value and excellent transparency to be effectively used as particularly a protective film for a polarizing filter. Note that a liquid crystal display obtained by adhering two polarizing filters, in which the film is attached to a polarizer, to a liquid crystal layer represents features such as excellent capability of displaying liquid crystal or the like. However, the location of the liquid crystal layer and the polarizing filter is not especially limited, and may be located in an arbitrary position based on a various known locations. Details about the liquid crystal displays of TN type, STN type, VA type, OCB type, reflective type, and other types are described in Japanese Patent Laid-Open Publication No. 2005-104148 (for example, in paragraphs [1088] to [1265]). The description is also applicable to the present invention. Additionally, in the same publication, there are described a cellulose acylate film provided with an optically anisotropic layer, a cellulose acylate film provided with antireflective and antiglare functions, and applications of an optical compensation film as a biaxial cellulose acylate film provided with adequate optical properties. The biaxial cellulose acylate film also may be combined together with a polarizing filter protecting film. The description is also applicable to the present invention.

Hereinafter, the present invention is described in detail referring to Examples. However, the present invention is not limited to these Examples.

### EXAMPLE 1

The dope 60 was prepared by mixing the following materials with use of the dope production apparatus 10 shown in FIG. 1. Note that in this example the dope 60 was prepared with use of a mixed solvent in which dichloromethane as the main solvent was mixed with methanol and 1-butanol.

### Materials of the Dope

Cellulose triacetate (powder having degree of substitution of 2.84, viscosity average polymerization degree of 306, water content of 0.2 mass %, viscosity in dichloromethane solution of 6 mass % of 315 m Pa·s, average particle diameter of 1.5 mm, and standard deviation of particle diameter of 0.55 mm) 100 parts by mass dichloromethane 320 parts by mass methanol 83 parts by mass 1-butanol 3 parts by mass plasticizer A (triphenyl phosphate) 7.6 parts by mass plasticizer B (diphenyl phosphate) 3.8 parts by mass UV agent a (2-(2′-hydroxy-3′,5′-di-tert-butylphenyl) benzotriazole) 0.7 parts by mass UV agent b (2-(2′-hydroxy-3′,5′-di-tert-amylphenyl)-5-chlorbenzotriazole) 0.3 parts by mass citric acid ester mixture (citric acid, monoethyl ester, diethyl ester, triethyl ester compound) 0.006 parts by mass fine particles (silicon dioxide (average particle diameter of 15 nm, Mohs hardness of 7) 0.05 parts by mass Triacetyl cellulose (TAC) used in this example was synthesized from cellulose that was extracted from cotton. As for such TAC, the residual amount of acetic acid was equal to or less than 0.1 mass %, the rate of content of Ca was 58 ppm, the rate of content of Mg was 42 ppm, the rate of content of Fe was 0.5 ppm, the rate of content of free acetic acid was 40 ppm, and the rate of content of sulfate ion was 15 ppm. The degree of acyl substitution at sixth position was 0.91, and 32.5% of whole acetyl groups was substituted by hydroxyl group at the sixth position. When extraction of TAC was applied with acetone, the extract content was 8 mass %. X/Y, which is a proportion of weight-average molecular weight X to number average molecular weight Y, was 2.5. Note that a yellow index of the obtained TAC was 1.7, the haze thereof was 0.08, the transparency thereof was 93.5%, Tg (glass transition temperature) measured by a differential scanning calorimetry (DSC) was 160° C., and calorific value of crystallization thereof was 6.4 J/g.

When preparing the dope, at first, to the dissolving tank 73 whose content was 4000 L and which was made of stainless, a mixture solvent was supplied from the first tank 70, and then flaky TAC powder was gradually supplied from the hopper 72 thereto. Thereafter, the first stirrer 92 having the anchor blade and the second stirrer 94 of dissolver type were caused to stir at a peripheral speed of 1 m/s and 5 m/s, respectively to disperse the TAC powder into the mixture solvent. Note that the temperature at the time of starting dispersing was 25° C., and the temperature finally rose to 48° C. Further, to the dissolving tank 72 N-N-di-m-toluyl-N-p-methoxyphenyl-1,3,5-triazine-2,4,6-triamine as a retardation controller was supplied. The amount of the retardation controller to be added was regulated such that its rate of content became 4.0 mass % relative to the total mass % of a film produced by the dope.

Next, the additive liquid preliminarily prepared was supplied from the second tank 71 to the dissolving tank 73 while regulating the amount of the additive liquid with use of the pump P2 such that the liquid content of the dissolving tank 73 became 2000 kg. Thereafter, after the first and second stirrers 92 and 94 were caused to rotate to disperse the additive liquid, the peripheral speed of the first stirrer 92 was switched to 0.5 m/s to stir for 100 minutes, thus obtaining the mixture 95. Note that during preparation of the mixture 95 nitrogen gas was fed into the dissolving tank 73 to pressurize the inside thereof to 0.12 MPa. Further, the oxygen concentration inside the dissolving tank 73 was regulated to less than 2 vol % to maintain a safe state in view of explosion proof. The proportion of water contained in the mixture 95 was 0.3 mass %.

The heater 75 provided with a heating/pressurizing function was used. The mixture 95 was fed into the heater 75 from the dissolving tank 73 while regulating the flow rate of the mixture 95 to heat the mixture 95 by the pump P3 to 50° C. Thereafter, the mixture 95 was heated to 90° C. under pressurization of 2 MPa to manufacture the polymer solution 99 in which TAC and the additive were completely dissolved into the solvent. Note that the heating time by the heater 75 was 15 minutes. Then, the polymer solution 99 was fed into the temperature regulator 76 to decrease the temperature thereof to 36° C. The polymer solution 99 was caused to pass the first filtration device 78 having a filter with pores whose nominal diameter each was 8 μm, thus removing foreign substances in the polymer solution 99. A primary pressure was 1.5 MPa and a secondary pressure was 1.2 MPa in the first filtration device 78. The pipes connecting the respective devices and the filter, which were subjected to high temperature, were made of Hastelloy alloy (trade name).

The polymer solution 99 before being concentrated was fed into the flash device 83 controlled at a condition of a normal pressure and 80° C., and subjected to flash evaporation to be concentrated to a desired concentration. The solid content degree of the polymer solution 99 after flash evaporation was 22.5 mass %. At this time, the solvent having evaporated due to the concentration was recovered by the recovery device 84 and refined by the refining device 85. Thereafter, the refined solvent was fed into the first tank 70 and reused as the solvent for preparing a dope. Distillation and dehydration were performed in the recovery device 84 and the refining device 85. Note that a flash tank (not shown) of the flash device 83 was provided with a stirrer (not shown) . A stirring shaft of the stirrer included an anchor blade. The polymer solution 99 after flash evaporation was stirred by the stirrer at a peripheral speed of 0.5 m/s to be defoamed. The temperature of the polymer solution 99 in the flash tank was 25° C., and the average retention time of the polymer solution 99 in the flash tank was 50 minutes. The polymer solution 99 after concentration was picked to measure its shearing viscosity at the temperature of 25° C. The measured shearing viscosity at a shearing speed of 10 sec⁻¹ was 450 Pa·s.

The polymer solution 99 after concentration was irradiated by weak ultrasonic wave to be defoamd. Thereafter the polymer solution 99 was fed into the second filtration device 79 pressurized to 1.5 MPa by the pump P4 and filtered therein, thus removing foreign substances. Note that, in the second filtration device 79, the polymer solution 99 was caused to pass a sintered fiber metal filter with pores whose nominal diameter each was 10 μm, and then was caused to pass a sintered fiber filter with pores whose nominal diameter each was 10 μm. Namely, the polymer solution 99 was subjected to a two-stage filtration. At this time, primary pressures of the respective filtration were 1.53 MPa and 1.2 MPa, and secondary pressures of the respective filtration were 1.0 MPa and 0.8 MPs. The polymer solution 99 after filtration was fed into the stock tank 80 whose content was 2000 L and which was made of stainless to be stored therein. In the stock tank 80, the polymer solution 99 was constantly stirred by the stirrer 98 with an anchor blade at its central shaft at a peripheral speed of 0.3 m/s to be retained uniformly. Additionally, a heat transfer medium was flown to the jacket 90 to regulate the temperature thereof. Therefore, the temperature of the polymer solution 99 stored in the stock tank 80 was regulated to 36° C.

An adequate amount of the polymer solution 99 was sent to the liquid supply line L1 from the stock tank 80 and filtered in the third filtration device 87, thus obtaining the dope 60. The dope 60 and the film production apparatus 10 (see FIG. 1) were used to produce the film 43. At first, the dope 60 was fed into the feed block 20 and subsequently fed into the casting die 22′. In this example, the casting die 22 was provided with a slit having a width of 1.8 m and a jacket (not shown) capable of regulating the internal temperature thereof. The casting die 22 sent a heat transfer medium to the jacket (not shown) to constantly regulate the internal temperature of the jacket such that the temperature of the dope 60 to be cast became 36° C. Note that, during the film production, the temperature of the feed block 22, the casting die 22, and the pipes were each kept at 36° C.

Further, the casting die 22 was a coat-hanger type die and provided with thickness adjusting bolts (heat bolts) at a pitch of 20 mm. Therefore, the casting die 22 was provided with an automatic thickness adjusting mechanism utilizing heat bolts. The heat bolts also could set a profile along a preset program in accordance with a liquid amount sent by a high-accuracy gear pump. Additionally, the heat bolts could perform feedback control along an adjustment program on the basis of a profile of an infrared thickness gauge (not shown) disposed inside the film production apparatus 40. A thickness difference between any two points, which were located within an area excepting a casting edge portion of 20 mm, of the film was set to be 1 μm or less. Further, the largest thickness difference in the width direction between the both minimum values was set to be 3 μm/m. The average thickness accuracy of each layer was regulated to ±2% or less in the surface layer, ±1% or less in the main layer (main stream), and the total thickness was regulated to ±1.5% or less.

As shown in FIG. 2, the dope 60 was cast onto the casting drum 23 from a casting aperture 22a of the casting die 22 while forming the casting bead 62. Note that the casting drum 23 was disposed just below the casting die 22 in the casting chamber 12, and made of SUS316 with its rotation frequency controlled by a driver (not shown). Further the flow rate of the dope 60 was regulated such that the thickness of the film 43 became 80 μm.

The casting drum 23 supplies the heat transfer medium, whose temperature was regulated to a predetermined value, from the cooling medium feeder 24 to a heat transfer medium passage disposed inside the casting drum 23. Then, the casting drum 23 caused the heat transfer medium to be circulated therein or pass therethrough, thus regulating its surface temperature to −7° C. The internal temperature of the casting chamber 12 was regulated to 35° C. by the temperature regulator 28. Further, a solvent vapor in the casting chamber 12 was condensed and liquidized by the condenser 26 to be recovered by the recovery device 27, and the resultant was refined by a refining device (not shown). The refined solvent was reused as the solvent for preparing the dope.

Next, the casting film 40 was peeled from the casting drum 23 to form the wet film 41. The peeling tension applied thereto was set to 1×10²N/m², and the peeling speed (peel roller draw) was regulated so as to be in the range of 100.1% to 110% relative to the rotation speed of the casting drum 23 in order to prevent defect of peeling. Note that the surface temperature of the released wet film 41 was 15° C.

Subsequently, the wet film 41 was fed to the transfer section 13 through the peel roller 25. In the transfer section 13, dry air whose temperature was adjusted to 40° C. was blown against the wet film 41 from the drying device 44 while the wet film 41 was transported by the support of plural rollers. Accordingly, the drying condition of the wet film 41 proceeded. Note that, in the transfer section 13, while the wet film 41 was transported, tensile force of approximately 30 N was applied thereto in the transporting direction thereof, thus performing uni-axial stretching for stretching the wet film 41 in the transporting direction thereof.

Next, the wet film 41 in the course of drying was fed into the tenter device 14. The tenter device 14 was a pin-type tenter device provided with a plurality of pins (not shown) running endlessly along the running of the chain and a heater (not shown). After the both side ends of the wet film 41 were fixed by being pierced by each of the pins, the wet film 41 was transported along the running of the chain while being dried, thus obtaining the film 43. Note that in the tenter device 14 the wet film 41 was stretched in the width direction thereof by regulating the width of a rail provided with the above chain. Further, the inside of the tenter device 14 was divided into a plurality of sections, where the temperature of the dry air was changed by a drying device (not shown) to dry the wet film 41 at various temperature stepwise.

The edge slitting device 51 was disposed at a portion to which it took 30 seconds or less from an exit of the tenter device. The edge slitting device 51 cut off the film 43 at a portion 50 mm away from the both side ends of the film 43 toward the inward. Note that in this example the edge slitting device 51 was provided with a NT-type cutter. Further, the both side ends thus cut off (edges) were pneumatically sent to the crusher 50 by a cutter blower (not shown) to be crushed into chips each of which was approximately 80 mm² on average. In this example, the chips were reused as a material for preparing a dope together with TAC powder.

A preliminary drying chamber (not shown) was disposed between the edge slitting device 51 and the drying chamber 15 to preheat the film 43 by supplying dry air at the temperature of 100° C. thereto before drying the film 43 in the drying chamber 15 at a high temperature in this example. The film 43 whose residual amount of the solvent became 5 wt % was fed into the drying chamber 15.

An air blower (not shown) was disposed in the drying chamber 15. Dry air whose temperature was regulated by the air blower was supplied to the film 43, thus regulating the surface temperature of the film 43 in a range of (140±40)° C. While the film 43 was transported at the transporting tension of 100 N/m with the support of the plurality of rollers 53, the film 43 was dried for approximately 10 minutes until the residual amount of the solvent definitely became 1 wt %. Note that in the drying chamber 15 the adsorption and recovery device 54 including active carbon as an absorbing agent and dry nitrogen as a desorbing agent recovered solvent gas in the drying chamber 15. Thereafter, water content was removed until the proportion of water contained in the solvent gas became 0.3 mass % or less. The resultant was reused as a solvent for preparing the dope.

Further, a humidity control chamber (not shown) was disposed between the drying chamber 15 and the cooling chamber 16. The humidity control chamber controlled the humidity of the film 43 to correct curing or the like. Note that, in the humidity control chamber, after air at a temperature of 50° C. and at a dew point of 20°0C was supplied to the film 43, subsequently, air at a temperature of 90° C. and at a degree of humidity of 70% was directly supplied to the film 43.

The film after the humidity control was fed into the cooling chamber 16 to be cooled until the temperature thereof became 30° C. or less. Further, the compulsory neutralization device (neutralization bar) 56 regulated the voltage applied to the film 43 such that the voltage remained constantly in the range of −3 kV to 3 kV. Thereafter, the knurling was formed on the both side ends of the film 43 by the knurling roller 57. Note that the knurling was formed by performing emboss processing starting from one end of the film 43 to the other end thereof. In this case, the width subjected to the knurling was 10 mm, and pressure applied by the knurling roller was regulated such that a height of the evenness was higher than the average height of the film 43 by 12 μm on average.

Finally, the winding roller 58 (having a diameter of 169 mm) disposed in the winding chamber 17 wound up the film 43 while adjusting the tensile force at the time of starting winding to 300 N/m and the tensile force at the time of finishing winding to 200 N/m, thus obtaining a roll of product of the film 43 which had a width of 1340 mm and an inner width of 1313 mm with knurling formed thereon. At the time of starting winding, the temperature of the film 43 was 23° C., proportion of water contained therein was 1.0 mass %, and the residual amount of the solvent was 1 mass %. Further, inside the winding chamber 17, while the room temperature was kept at 28° C. and the humidity was kept at 70%, there was disposed a neutralization device utilizing ionic wind (not shown) to regulate the voltage applied to the film 43 to be in the range of −1.5 kV to 1.5 kv. Further, at the time of winding, a fluctuation band of winding dislocation (width of oscillation) was set to −5 mm, winding dislocation cycle relative to the winding roller 58 was set to 400 m, and pressure applied from the press roller 59 to the winding roller 58 was set to 50 N/m. Note that, in the film production apparatus 10, through the entire processes, average drying speed of the casting film 40, wet film 41, and the film 43 was set to 20 wt %/m.

In example 1, as shown in FIG. 2, in casting the dope 60 onto the casting drum 23, nitrogen gas was supplied to the casting chamber 12, and oxygen concentration inside the casting chamber 12 was set to 0 vol % or more and less than 10 vol %. Under the above condition, the voltage of the static electricity applying electrode 34 was set to 10 kV, and static electricity was applied between the casting drum 23 and the casting bead 62. Further, as an adhesion device for the casting drum 23 and the casting bead 62, the suction chamber 30 and the intervening film forming device 32 were used to decompress the downstream area from the casting bead 62 to −400 Pa and supply the intervening film forming liquid 64 along the entire surface of the casting bead 62 at the side facing the support. Note that the intervening film forming liquid 64 was dichloromethane, and flow rate of the liquid was regulated such that the thickness of the intervening film 65 became 5 μm. The suction chamber 30 included the casting bead 62 provided with a labyrinth packing (not shown) on its front and rear ends respectively and an aperture on its both side ends. The suction chamber 30 also included an edge suction device (not shown) for regulating disturbance of the both side ends of the casting bead 62.

On the basis of the measured value of oxygen concentration sent from the oxygen meter 35, while the controller 37 kept the oxygen concentration inside the casting chamber 12, the film forming speed was gradually made faster. At the time of casting, occurrence of phenomenon of air entrainment between the casting bead 62 and the casting drum 23 was observed with eyes. As a result, at the film forming speed of 110 m/m, occurrence of the phenomenon of air entrainment was confirmed for the first time. Note that the description is performed hereinbelow by considering degree of suction by the suction chamber 30, oxygen concentration, voltage in applying static electricity, and the like in casting the dope 60 as conditions for casting.

### EXAMPLE 2

In Example 2, in casting the dope 60 onto the casting drum 23, only the suction chamber 30 was used as the adhesion device. The other conditions are the same as those in Example 1. As in the case of Example 1, while keeping the conditions for casting as well as speeding up the film forming speed gradually, whether phenomenon of air entrainment occurs or not was checked. As a result, at the film forming speed of 90 m/m, occurrence of the phenomenon of air entrainment was confirmed.

### EXAMPLE 3

In Example 3, in casting the dope 60 onto the casting drum 23, the voltage applied by the static electricity applying electrode 34 was set to 12 kV, and only the suction chamber 30 was used as the adhesion device. The other conditions are the same as those in Example 1. As in the case of Example 1, while keeping the conditions for casting as well as speeding up the film forming speed gradually, whether phenomenon of air entrainment occurs or not was checked. As a result, at the film forming speed of 110 m/m, occurrence of the phenomenon of air entrainment was confirmed.

### EXAMPLE 4

In Example 4, in casting the dope 60 onto the casting drum 23, the intervening film forming device 32 was used as the adhesion device, and the intervening film forming liquid 64 (dichloromethane) was supplied along the entire surface of the casting bead 62 at the side facing the support such that the thickness of the intervening film 65 became 5 μm. The other conditions are the same as those in Example 1. As in the case of Example 1, while keeping the conditions for casting as well as speeding up the film forming speed gradually, whether phenomenon of air entrainment occurs or not was checked. As a result, at the film forming speed of 100 m/m, occurrence of the phenomenon of air entrainment was confirmed.

### EXAMPLE 5

In Example 5, in casting the dope 60 onto the casting drum 23, the intervening film forming device 32 was used as the adhesion device, and the intervening film forming liquid 64 (dichloromethane) was supplied along the both side ends of the casting bead 62 at the side facing the support. The other conditions are the same as those in Example 1. As in the case of Example 1, while keeping the conditions for casting as well as speeding up the film forming speed gradually, whether phenomenon of air entrainment occurs or not was checked. As a result, at the film forming speed of 80 m/m, occurrence of the phenomenon of air entrainment was confirmed.

### COMPARATIVE EXAMPLE 1

In Comparative Example 1, in casting the dope 60 onto the casting drum 23, no adhesion device was used. The other conditions are the same as those in Example 1. As in the case of Example 1, while keeping the conditions for casting as well as speeding up the film forming speed gradually, whether phenomenon of air entrainment occurs or not was checked. As a result, at the film forming speed of 60 m/m, occurrence of the phenomenon of air entrainment was confirmed.

### COMPARATIVE EXAMPLE 2

In Comparative Example 2, in casting the dope 60 onto the casting drum 23, the voltage applied by the static electricity applying electrode 34 was set to 12 kV, and no adhesion device was used. The other conditions are the same as those in Example 1. As in the case of Example 1, while keeping the conditions for casting as well as speeding up the film forming speed gradually, whether phenomenon of air entrainment occurs or not was checked. As a result, at the film forming speed of 70 m/m, occurrence of the phenomenon of air entrainment was confirmed.

### EXAMPLE 6

In Example 6, in casting the dope 60 onto the casting drum 23, the air knife disposed in the downstream side from a spot where the casting bead 62 reached the casting drum 23 was used as the adhesion device, and air was supplied thereto such that wind velocity at the vicinity of the casting bead 62 became 10 m/s. The other conditions are the same as those in Example 1. As in the case of Example 1, while keeping the conditions for casting as well as speeding up the film forming speed gradually, whether phenomenon of air entrainment occurs or not was checked. As a result, at the film forming speed of 70 m/m, occurrence of the phenomenon of air entrainment was confirmed.

In every example, since static electricity was applied in a state where oxygen concentration was in a predetermined range, even when static electricity application was performed in the casting chamber 12 including the solvent vapor therein, it was possible to prevent fire and explosion. However, in view of film forming speed at the time of occurrence of phenomenon of air entrainment, in Comparative Examples 1 and 2, phenomenon of air entrainment occurred at significantly lower speed in comparison with other Examples. This was because, in Examples 1 to 5 and 6, in addition to static electricity application, the suction chamber, the intervening film forming device, the air knife, and the like were used as the adhesion device, and therefore the extent of the adhesion between the casting drum 23 and the casting bead 62 could be further enhanced, thus resulting in suppression of the phenomenon of air entrainment. Note that it was also confirmed that, when speeding up the film forming speed, in addition to the static electricity application, at least two adhesion devices were preferably used. Further, it was also confirmed that, when using the intervening film forming device 32, supplying the intervening film forming liquid 64 along the entire surface of the casting bead 62 at the side facing the support provided excellent result on improvement in adhesion.

In view of the above, it was confirmed that, while static electricity was applied in a state where oxygen concentration was 0 vol % or more and less than 10 vol %, the dope was cast and the adhesion means for adhering the ribbon-shaped casting bead and the support together was used, thus resulting in suppression of fire and explosion, formation of the casting bead having a stable shape, and achievement in high adhesion between the casting bead and the support even if the voltage was high in static electricity application. Additionally, it was also confirmed that, as the adhesion device, the suction chamber, the intervening film forming device, and the air knife were effective, and that in addition to the static electricity application, at least one of those was used, thus enhancing the above effect.

### INDUSTRIAL APPLICABILITY

The present invention is preferably utilized in production of an optical film.

1. A production method of a polymer film comprising:
casting a polymer solution containing a polymer and a solvent from a casting die onto a moving support to form a casting film;
applying static electricity between said support and a casting bead extending from said casting die to said support at oxygen concentration set to 0 vol % or more and less than 10 vol %, an adhesion device increasing the extent of adhesion between said casting bead and said support;
peeling off said casting film as a wet film from said support; and
drying said wet film by a drier to form a polymer film.

2. A production method of a polymer film as defined in claim 1, wherein said adhesion device includes at least one of a suction unit to decompress an upstream area from said casting bead in a running direction of said support, an air knife to flow air against said casting bead having reached said support, and a liquid layer forming unit to form a liquid layer between said support and said casting film by supplying a liquid thereto.

3. A production method of a polymer film as defined in claim 1, wherein said liquid contains said solvent.

4. A production apparatus of a polymer film comprising:
a casting film forming device for casting a polymer solution containing a polymer and a solvent from a casting die onto a moving support to form a casting film;
a drying device for drying said casting film peeled from said support by a drier to form a polymer film;
an oxygen concentration controlling unit for controlling oxygen concentration at the vicinity of a casting bead set to 0 vol % or more and less than 10 vol %, said casting bead extending from said casting die to said support;
a static electricity application unit for applying static electricity between said casting bead and said support; and
an adhesion device for increasing the extent of adhesion between said casting bead and said support.

5. A production apparatus of a polymer film as defined in claim 4, wherein said adhesion device comprises at least one of a suction unit, an air knife, and a liquid layer forming unit.
